(19) United States
(12) Patent Application Publication
(10) Pub. No.: US 2009/0168779 A1
(43) Pub. Date: Jul. 2, 2009

(54) Integration of multi-protocol label switching (MPLS)

(76) Inventor: Loc Q. Nguyen, Beaverton, OR (US)

Correspondence Address: Caven & Aghevli LLC;c/o CPA Global, P.O. BOX 52050, MINNEAPOLIS, MN, 55402, US

(21) Appl. No.: 12/006,162

(22) Filed: Dec. 31, 2007

(51) Int. Cl. H04L 12/56

(52) U.S. Cl. 370/392

(57) ABSTRACT

Methods and apparatus relating to integration of Multi-Protocol Label Switching (MPLS) are described. In an embodiment, MPLS labels may be inserted into incoming Internet Protocol (IP) packets to form MPLS packets. Other embodiments are also disclosed.

### FIELD

The present disclosure generally relates to the field of electronics. More particularly, an embodiment of the invention generally relates to integration of MPLS (Multi-Protocol Label Switching).

### BACKGROUND

Networking has become an integral part of computing. Networks may generally be used to share data between computing devices. One common approach to routing data between various devices is to assign an Internet Protocol (IP) address to each device (or collection of devices). Unlike a telephone network though, an IP address based routing of data is generally performed with no control over the actual route the data is to take. Further, data may be transferred in pieces referred to as packets. Sometimes packets for the same set of data may be routed via different routes to a destination. This can be problematic as the packets may arrive at different times, for example, out of order.

MPLS labels may be used to improve speed of packet forwarding, e.g., when compared with IP lookup forwarding. Also, MPLS labels may allow for routing of network traffic in determined fashion. However, to implement MPLS, one or more dynamic routing protocols may need to be used, such as BGP (Border Gateway Protocol), LDP (Label Distribution Protocol), or RSVP (Resource Reservation Protocol). Accordingly, current implementations may not be able to use MPLS in environments where such protocols are absent.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures may indicate similar items.

FIG. 1 illustrates a sample MPLS packet which may be used in some embodiments of the invention.

FIG. 2 illustrates a sample MPLS header which may be used in some embodiments of the invention.

FIGS. 3-5 illustrate flow diagrams in accordance with some embodiments of invention.

FIG. 6 illustrates a sample entry of an MPLS table, in accordance with one embodiment.

FIG. 7 illustrates a block diagram of an embodiment of a computing system, which may be utilized to implement some embodiments discussed herein.

### DETAILED DESCRIPTION

In the following description, numerous specific details are set forth in order to provide a thorough understanding of various embodiments. However, various embodiments of the invention may be practiced without the specific details. In other instances, well-known methods, procedures, components, and circuits have not been described in detail so as not to obscure the particular embodiments of the invention. Further, various aspects of embodiments of the invention may be performed using various means, such as integrated semiconductor circuits (“hardware”), computer-readable instructions organized into one or more programs (“software”), or some combination of hardware and software. For the purposes of this disclosure reference to “logic” shall mean either hardware, software, or some combination thereof.

Some embodiments discussed herein may allow for usage of MPLS labels in environments (e.g., small networks, such as small business networks, home networks, etc.) where underlying dynamic routing protocols (such as BGB, LDP, RSVP, etc.) are absent. In some embodiments, MPLS labels discussed herein may be in accordance with Request For Comments (RFC) 3031 and/or RFC 3032, Internet Society, both published January 2001. Furthermore, in an embodiment, the MPLS labels may reside in layer 3 in the OSI (Open System Interconnection). The OSI reference model generally defines a networking framework and is developed by the International Standards Organization. It may sit on top of another layer 3 protocol. Examples of other layer 3 protocols which may be used for MPLS labels may include IP version 6 (IPv6) (e.g., such as described by the Internet Society RFC 2460 (December 1998) and 3513 (April 2003)) or IP version 4 (IPv4) (e.g., such as described by the Internet Society RFC 791 (September 1981)). In some embodiments, using MPLS (e.g., in a network router or modem device (such as a cable modem, DSL (Digital Subscriber Line) modem, etc.) may allow for faster packet forwarding since MPLS lookup is faster than IP lookup and/or allow traffic engineers to route traffic in determined fashion.

FIG. 1 illustrates a sample MPLS packet which may be used in some embodiments of the invention. As shown, an MPLS header 102 may be inserted on top of an IP header 104 and an IP payload 106. Other configurations are also possible, for example, inserting the MPLS header 102 in other locations relative to the IP header 104 and/or IP payload 106.

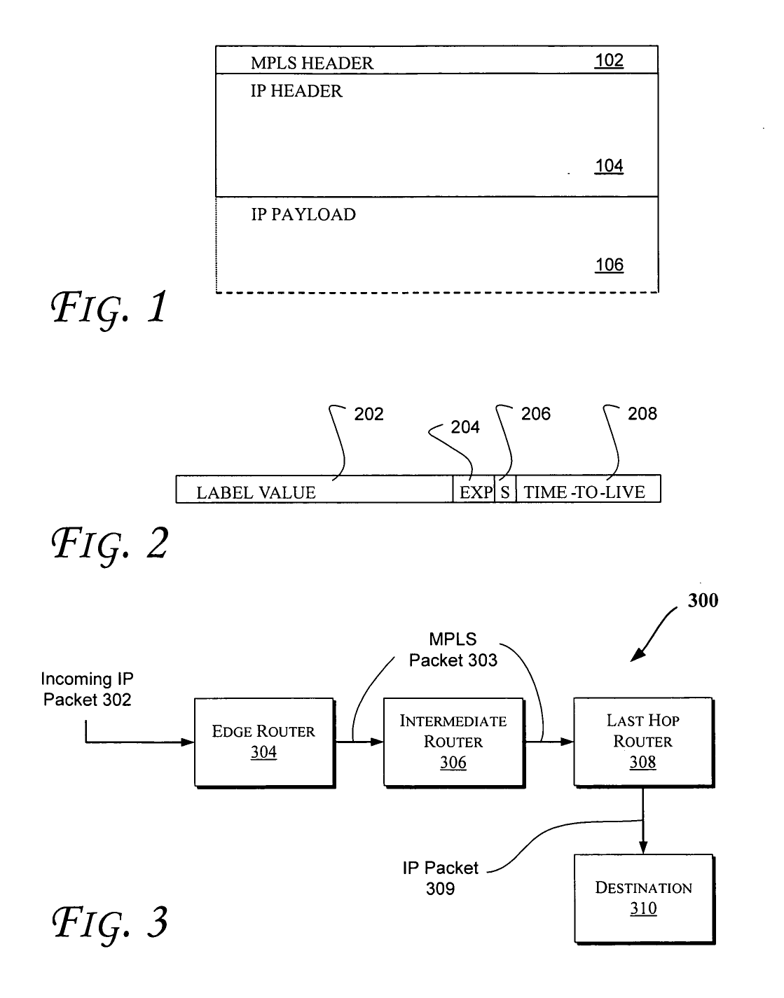

FIG. 2 illustrates a sample MPLS header which may be used in some embodiments of the invention. In some embodiments, the MPLS header 102 of FIG. 1 may include more than one entry in accordance with the MPLS header shown in FIG. 2. For example, the MPLS header 102 may include two entries that are to be added to an IP packet (e.g., one including a control label and another one a routing label). In one embodiment, each entry of the MPLS header 102 may have the same or similar format as the header shown in FIG. 2. The MPLS header shown in FIG. 2 may comply with RFC 3032 in an embodiment. The MPLS label header may include 32 bits. The first 20 bits may include a label value 202 (which may be routing or control labels as will be further discussed herein, e.g., with reference to FIGS. 3-6). The next 3 bits (exp, e.g., for experimental) 204 may be used for QoS (Quality of Service) priority indication. The following bit 206 (which may be referred to as stack (S)) may indicate whether or not this label is the last label. The next 8 bits 208 may be for the time-to-live of the packet (e.g., which may be copied from the value of time-to-live field of the IP header under neat, may indicate when the packet is discarded by a router—the value may decrease as the packet travels and dropped when the value reaches zero, for example). The order of the various bits may be rearranged in some embodiments.

FIG. 3 illustrates a flow diagram 300 of transformation of an IP packet before reaching a destination, according to an embodiment. As shown, an incoming IP packet 302 may be received at an edge router 304 (e.g., including for example, a network router that is coupled to an external computer network such as the Internet). Examples of the edge router 304 include, but are not limited to, a cable modem, a DSL modem, etc. The router 304 may add an MPLS header (e.g., header 102 of FIG. 1) to the IP packet 302 to generate an MPLS packet 303 which is then forwarded to one or more other router(s) such as an intermediate router 306, and/or a last hop router 308. As shown, last router before a destination 310 (e.g., the last hop router 308) may convert the MPLS packet 303 back into an IP packet 309 (e.g., by removing or stripping the MPLS header added by the edge router 304). In one embodiment, the IP packet 309 may be the same or similar to the incoming IP packet 302.

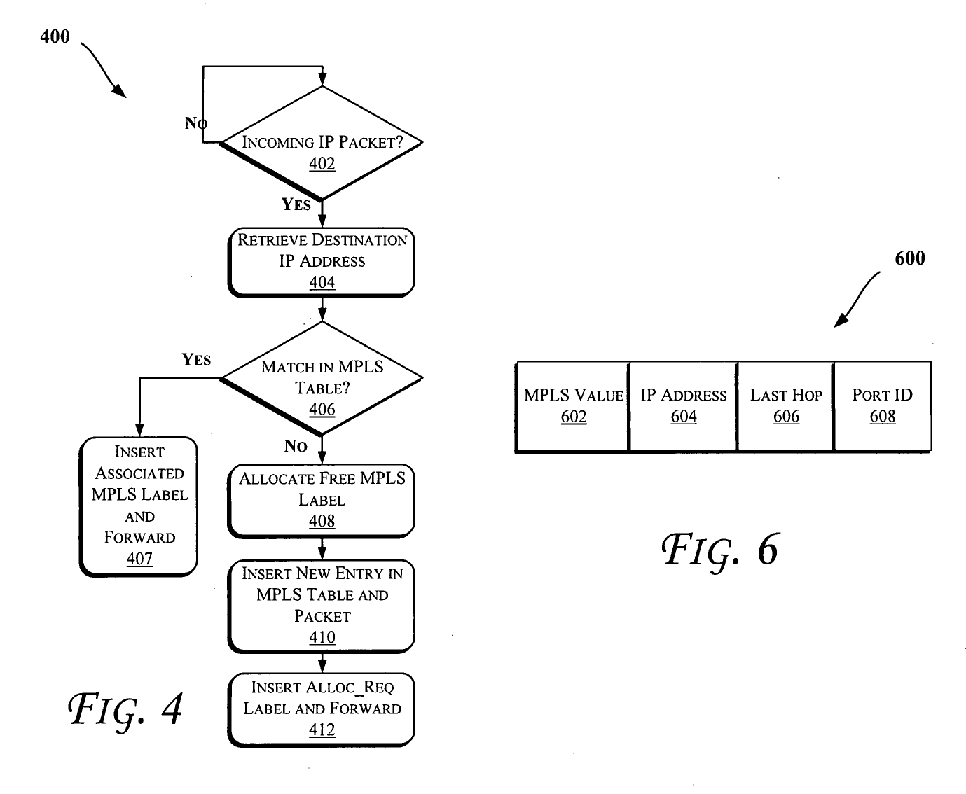

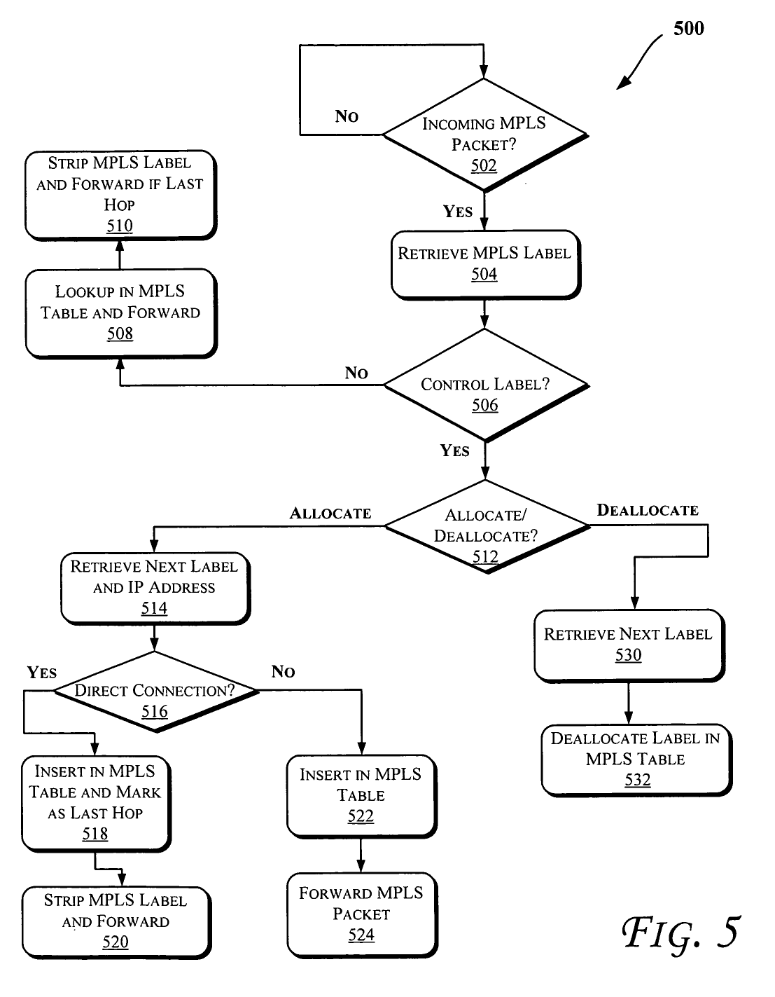

FIG. 4 illustrates a flow diagram of a method 400, according to one embodiment. In some embodiments, one or more of the operations discussed with reference to FIG. 4 may be performed at an edge router (such as logic within the edge router 304 of FIG. 3). FIG. 5 illustrates a flow diagram of a method 500, according to one embodiment. In some embodiments, one or more of the operations discussed with reference to FIG. 5 may be performed at a router other than an edge router (such as logic within one or more of the routers 306 and/or 308 of FIG. 3).

In one embodiment, at least two control labels may be utilized to enable MPLS in various networking environments (e.g., in the absence of underlying dynamic routing protocols such as BGB, LDP, RSVP, etc.). In an embodiment, control labels may be in the range [0 to 15]. Two different MPLS control labels may be used in conjunction with allocate and deallocate methods (e.g., such as discussed with reference to FIGS. 4 and/or 5) to enable forwarding based on MPLS labels in environments where dynamic routing protocols may not be available (such as a home network, small business network, etc.). In an embodiment, label 15 may used for allocating (Alloc_Req or Allocation Request) and label 14 may be used for de-allocating (Alloc_Release or Deallocation). Furthermore, routing labels (in contrast to control labels) may be in the range [16 to 1023].

Referring to FIGS. 1-4, at an operation 402, it may be determined whether an IP packet has been received (e.g., packet 302). The received IP packet may be destined for a computing device coupled to an external network (e.g., the Internet) via an edge router (such as the router 304) where the IP packet is received. At an operation 404, the destination of the IP packet (e.g., identified by an IP address) may be extracted or retrieved (e.g., by the edge router 304).

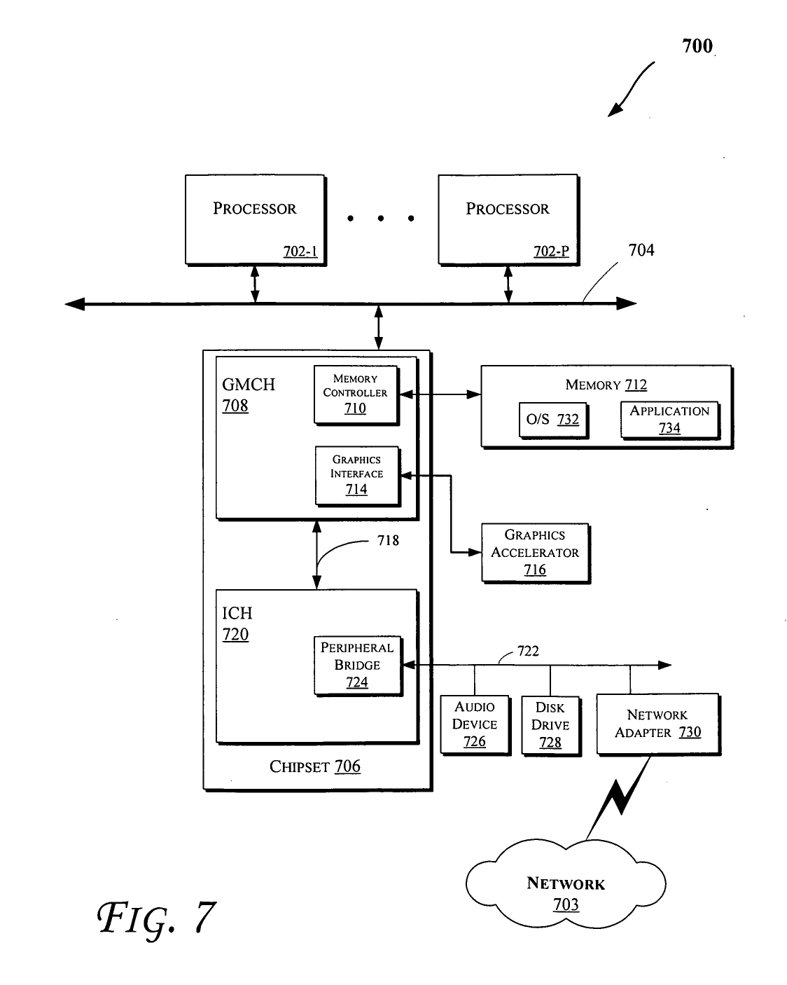

At an operation 406, it may be determined whether there is a match in an MPLS table (which may be stored in the edge router 304 or at other locations within a network accessible to the edge router 304 such as routers 306 and/or 308, and/or one or more computing devices including for example the destination 310). In one embodiment, the operations discussed with reference to FIG. 4 may be for a destination IP address which is not directly coupled to an edge router. If the destination IP address is directly coupled to an edge router, then normal IP forwarding may be utilized. The MPLS table may also be stored in a storage device coupled to a network directly (e.g., a Networked Attached Storage (NAS) device, a computer server, etc.). Various components that may be utilized for such a device are further discussed with reference to FIG. 7. Also, each of the routers (e.g., discussed with reference to FIG. 3 for example) may maintain its own MPLS routing table. A sample entry 600 of an MPLS table is shown in FIG. 6, in accordance with one embodiment.

As shown in FIG. 6, each entry may include an MPLS routing value 602 (e.g., in the range of 16 to 1023), a corresponding IP address 604, and a last hop indicator 606 (e.g., including one or more bits that indicate whether the destination is directly coupled to the router that corresponds to the MPLS table at issue). In some embodiments, each entry may also include a corresponding port identifier (ID) 608 through which the packet is communicated to the destination. In some embodiments, the port identifier 608 may be part of the entry in the IP lookup table (not shown, but which may be present within each router discussed herein or otherwise accessible by each router as discussed with reference to MPLS table, for example) and may be used to send the corresponding IP packet to that port. For example, when performing IP lookup, if the destination IP is found in the IP lookup table, the port identifier for that IP is used to send the IP packet. In some embodiments, when the MPLS table is built, each entry may have an MPLS label, a corresponding IP address, the corresponding port identifier, and the last hop indicator. The order of fields 602 through 608 may be different in various embodiments. Furthermore, in an embodiment, there may be 1008 entries in the MPLS table (one for each label in the range of 16 to 1023, for example).

Referring to FIG. 4, if a match in the MPLS table is found, at an operation 407, the matched MPLS label from the MPLS table may be inserted into an MPLS header (such as discussed with reference to FIGS. 1-2), e.g., on top of the IP packet, to form an MPLS packet. The MPLS header entry may also be updated to indicate that the inserted label is the last label by setting or clearing the bit 206, e.g., depending on the implementation. The MPLS packet may then be forwarded to the next hop (e.g., on an identified port 608 such as indicated by the MPLS table). Otherwise, if no match in the MPLS table exists, at an operation 408, a free MPLS label may be allocated (e.g., in the range of 16-1023). At an operation 410, a new (routing) entry corresponding to the newly allocated label may be inserted into the MPLS table and the MPLS (routing) label may be inserted into an MPLS header (such as discussed with reference to FIGS. 1-2), e.g., on top of the IP packet, to form an MPLS packet (e.g., with bit 206 indicating that this is the last label of the MPLS header in an embodiment). At an operation 412, a control label indicating the allocation request (e.g., Alloc-Req or label value 15 in an embodiment) may be added on top of the formed MPLS packet (e.g., as an additional MPLS header entry such as discussed with reference to FIGS. 1-2). The control label entry may indicate that this is not the last label, e.g., by setting or clearing bit 206 depending on the implementation. The updated MPLS packet may then be forwarded to the next hop (e.g., utilizing the corresponding port identifier in the IP lookup table).

Referring to FIGS. 1-5, at an operation 502, it may be determined whether an MPLS packet has been received (e.g., by a router such as one of router 306 or 308). At an operation 504, the first label of the MPLS packet may be extracted or retrieved. If the extracted label is not a control label (e.g., not in range of 0 to 15 or otherwise in the range of 16 to 1023 in some embodiments), a corresponding entry in the MPLS table may be looked up and the packet may be forwarded to the next hop. If the MPLS table indicates a last hop, then the MPLS label (and MPLS header information) may be stripped from the packet prior to forwarding to the destination (e.g., destination 310) at operation 510.

At operation 506, if the first label is a control label, an operation 512 may determine whether the control label is an allocate or a deallocate label. If it is an allocate label (e.g., indicated by a label value 15 in an embodiment), an operation 514 may retrieve the next label and corresponding IP address from the MPLS table. If the coupled directly (as determined at operation 516), the label value may be inserted in the MPLS table and marked as last hop at an operation 518. At an operation 520, the MPLS label (and MPLS header information) may be stripped from the packet and the packet is subsequently forwarded to the destination (e.g., as discussed with reference to packet 309). Otherwise, at operation 516, if there is not direct coupling between the router and destination, an operation 522 may insert the label and corresponding information into the MPLS table (e.g., indicating that is not the last hop). An operation 524 may forward the MPLS packet to the next hop.

At operation 512, if the control label indicates a deallocation (e.g., label value 14 in an embodiment), the next label within the incoming packet of operation 504 may be retrieved at operation 530. At an operation 532, the MPLS label and its corresponding information (e.g., the corresponding entry) may be deallocated from MPLS table.

In some embodiments, deallocation may be triggered by an edge router (e.g., router 304 of FIG. 3). When the edge router detects that an MPLS entry is not used for a certain time (e.g., an MPLS entry is not used in the last 24 hours, for example), then the edge router may deallocate that MPLS label to save resources. Accordingly, in some embodiments, each entry of the MPLS table may also include an age field (e.g., indicating when the entry was created). To deallocate an MPLS label, the edge router may retrieve the corresponding IP address corresponding to the entry, build a packet with that destination IP address, insert the corresponding MPLS label with last label field set on top of the IP packet, insert a control label (e.g., deallocate label) on top, and then forward the generated MPLS packet using the corresponding port identifier. Subsequently, the MPLS entry may be removed from in the MPLS table.

FIG. 7 illustrates a block diagram of a computing system 700 in accordance with an embodiment of the invention. One or more of the components discussed with reference to FIG. 7 may be used in computing devices discussed herein, such as any of routers (e.g., 304-308 of FIG. 3) or computing devices (e.g., destination 310 of FIG. 3). The computing system 700 may include one or more central processing unit(s) (CPUs) or processors 702-1 through 702-P (which may be referred to herein as “processors 702” or “processor 702”). The processors 702 may communicate via an interconnection network (or bus) 704. The processors 702 may include a general purpose processor, a network processor (that processes data communicated over the computer network 703), or other types of a processor (including a reduced instruction set computer (RISC) processor or a complex instruction set computer (CISC)). Moreover, the processors 702 may have a single or multiple core design. The processors 702 with a multiple core design may integrate different types of processor cores on the same integrated circuit (IC) die. Also, the processors 702 with a multiple core design may be implemented as symmetrical or asymmetrical multiprocessors. In an embodiment, various operations discussed herein may be performed by one or more components of the system 700.

A chipset 706 may also communicate with the interconnection network 704. The chipset 706 may include a graphics memory control hub (GMCH) 708. The GMCH 708 may include a memory controller 710 that communicates with a main system memory 712. The memory 712 may store data, including sequences of instructions that are executed by the processor 702, or any other device included in the computing system 700. In one embodiment of the invention, the memory 712 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 704, such as multiple CPUs and/or multiple system memories.

The GMCH 708 may also include a graphics interface 714 that communicates with a graphics accelerator 716. In one embodiment of the invention, the graphics interface 714 may communicate with the graphics accelerator 716 via an accelerated graphics port (AGP). In an embodiment of the invention, a display (such as a flat panel display, a cathode ray tube (CRT), a projection screen, etc.) may communicate with the graphics interface 714 through, for example, a signal converter that translates a digital representation of an image stored in a storage device such as video memory or system memory into display signals that are interpreted and displayed by the display. The display signals produced by the display device may pass through various control devices before being interpreted by and subsequently displayed on the display.

A hub interface 718 may allow the GMCH 708 and an input/output control hub (ICH) 720 to communicate. The ICH 720 may provide an interface to I/O devices that communicate with the computing system 700. The ICH 720 may communicate with a bus 722 through a peripheral bridge (or controller) 724, such as a peripheral component interconnect (PCI) bridge, a universal serial bus (USB) controller, or other types of peripheral bridges or controllers. The bridge 724 may provide a data path between the processor 702 and peripheral devices. Other types of topologies may be utilized. Also, multiple buses may communicate with the ICH 720, e.g., through multiple bridges or controllers. Moreover, other peripherals in communication with the ICH 720 may include, in various embodiments of the invention, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 722 may communicate with an audio device 726, one or more disk drive(s) 728, and one or more network interface device(s) 730 (which is in communication with the computer network 703 and may comply with one or more of the various types of communication protocols discussed herein). In an embodiment, the network interface device 730 may be a NIC. Other devices may communicate via the bus 722. Also, various components (such as the network interface device 730) may communicate with the GMCH 708 in some embodiments of the invention. In addition, the processor 702 and other components shown in FIG. 7 (including but not limited to the GMCH 708, one or more components of the GMCH 708 such as the memory controller 710, etc.) may be combined to form a single chip. Furthermore, a graphics accelerator may be included within the GMCH 708 in some embodiments of the invention.

Furthermore, the computing system 700 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 728), a floppy disk, a compact disk ROM (CD-ROM), a digital versatile disk (DVD), flash memory, a magneto-optical disk, or other types of nonvolatile machine-readable media that are capable of storing electronic data (e.g., including instructions). In an embodiment, components of the system 700 may be arranged in a point-to-point (PtP) configuration. For example, processors, memory, and/or input/output devices may be interconnected by a number of point-to-point interfaces.

Additionally, in various embodiments, the network 703 (which may be coupled to the edge router 304 in an embodiment to communicate the incoming IP packet 302) may utilize any type of communication protocol such as Ethernet, Fast Ethernet, Gigabit Ethernet, wide-area network (WAN), fiber distributed data interface (FDDI), Token Ring, leased line, analog modem, digital subscriber line (DSL and its varieties such as high bit-rate DSL (HDSL), integrated services digital network DSL (IDSL), etc.), asynchronous transfer mode (ATM), cable modem, and/or FireWire.

Wireless communication through the network 703 may be in accordance with one or more of the following: wireless local area network (WLAN), wireless wide area network (WWAN), code division multiple access (CDMA) cellular radiotelephone communication systems, global system for mobile communications (GSM) cellular radiotelephone systems, North American Digital Cellular (NADC) cellular radiotelephone systems, time division multiple access (TDMA) systems, extended TDMA (E-TDMA) cellular radiotelephone systems, third generation partnership project (3G) systems such as wide-band CDMA (WCDMA), etc. Moreover, network communication may be established by internal network interface devices (e.g., present within the same physical enclosure as a computing system) or external network interface devices (e.g., having a separate physical enclosure and/or power supply than the computing system to which it is coupled) such as a network interface card or controller (NIC).

In various embodiments of the invention, the operations discussed herein, e.g., with reference to FIGS. 1-7, may be implemented as hardware (e.g., logic circuitry), software, firmware, or any combinations thereof, which may be provided as a computer program product, e.g., including a machine-readable or computer-readable medium having stored thereon instructions (or software procedures) used to program a computer (e.g., including a processor) to perform a process discussed herein. The machine-readable medium may include a storage device such as those discussed herein.

Additionally, such computer-readable media may be downloaded as a computer program product, wherein the program may be transferred from a remote computer (e.g., a server) to a requesting computer (e.g., a client) by way of data signals embodied in a carrier wave or other propagation medium via a communication link (e.g., a bus, a modem, or a network connection).

Reference in the specification to “one embodiment” or “an embodiment” means that a particular feature, structure, and/or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments of the invention, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments of the invention have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. An apparatus comprising:
a storage device to store an entry corresponding to an Internet Protocol (IP) packet, wherein the entry comprises a Multi-Protocol Label Switching (MPLS) value and a destination IP address of the IP packet; and
logic to generate an MPLS packet based on the MPLS value and the IP packet.

2. The apparatus of claim 1, wherein the MPLS packet comprises an MPLS header and wherein the MPLS header comprises one or more labels.

3. The apparatus of claim 2, wherein the one or more labels comprise a control MPLS label and a routing MPLS label.

4. The apparatus of claim 3, wherein the control MPLS label comprises one or more of an allocate label or a deallocate label.

5. The apparatus of claim 1, further comprising logic to forward the MPLS packet to a next hop.

6. The apparatus of claim 5, wherein the next hop comprises one or more routers and wherein at least one of the one or more routers comprises a second storage device to store an entry corresponding to the MPLS packet.

7. The apparatus of claim 6, wherein the at least one of the one or more routers is to deallocate an entry from the second storage device in response to a deallocation indication of the MPLS packet.

8. The apparatus of claim 6, wherein the at least one of the one or more routers is to allocate the entry corresponding to the MPLS packet in the second storage device in response to an allocation indication of the MPLS packet.

9. The apparatus of claim 6, wherein at least one of the one or more routers comprises one or more of an intermediate router or a last hop router.

10. The apparatus of claim 1, wherein the entry is to comprises one or more of a last hop field and a port identifier field.

11. The apparatus of claim 1, further comprising an edge router that is to comprise the storage device and the logic.

12. A method comprising:
extracting an IP address from an incoming IP packet;
storing an entry corresponding to the IP packet, wherein the entry comprises an MPLS value and a destination IP address of the IP packet; and
generating an MPLS packet based on at least a portion of information stored in the entry and the IP packet.

13. The method of claim 12, further comprising allocating a free MPLS label for the entry.

14. The method of claim 12, inserting an MPLS header on top of the IP packet to form the MPLS packet.

15. The method of claim 14, wherein the MPLS header is to comprise at least two labels selected from a group consisting of a control MPLS label and a routing MPLS label.
